(19) United States
(12) Patent Application Publication
(10) Pub. No.: US 2025/0238725 A1
(43) Pub. Date: Jul. 24, 2025

(54) DEVICE AND METHOD FOR PREDICTING OBSERVATIONS

(71) Applicant: Robert Bosch GmbH, Stuttgart (DE)

(72) Inventors: Filip De Roos, Stuttgart (DE); Fabio Muratore, Stuttgart (DE); Christoph Zimmer, Stuttgart (DE)

(21) Appl. No.: 18/985,658

(22) Filed: Dec. 18, 2024

(30) Foreign Application Priority Data
Jan. 19, 2024 (DE) 10 2024 200 505.3

(51) Int. Cl. G06N 20/00

(52) U.S. Cl. CPC G06N 20/00

(57) ABSTRACT

A computer implemented method for predicting observations. The method includes providing an input for predicting an observation, and training data comprising pairs of an input and an observation, wherein the input characterizes a technical system, and the observation characterizes the technical system or an environment of the technical system; determining, for the inputs, a covariance matrix of the inputs; determining a pivoted Cholesky decomposition of the covariance matrix; and determining a prediction for an observation depending on the pivoted Cholesky decomposition of the covariance matrix; wherein determining the pivoted Cholesky decomposition includes determining a covariance matrix of selected inputs and a covariance matrix of remaining inputs representing the covariance matrix of the inputs, determining a pivot ndex depending on a measure for a difference between the covariance matrix of the remaining inputs and a Nystrom approximation of the covariance matrix of the remaining inputs.

### CROSS REFERENCE

The present application claims the benefit under 35 U.S.C. § 119 of German Patent Application No. DE 10 2024 200 505.3 filed on Jan. 19, 2024, which is expressly incorporated herein by reference in its entirety.

### FIELD

The present invention relates to a device and a method for predicting observations.

### BACKGROUND INFORMATION

Observations may be predicted for a control, a classification, or a regression task.

Predicting observations may require numerically determining a Cholesky decomposition of a symmetric and positive definite N×N matrix. The runtime for determining the Cholesky decomposition scales cubically with the matrix dimensionality 0 (N³).

Applying a pivoted Cholesky decomposition determines an approximation of the Cholesky decomposition in M iterations and reduces the runtime to 0 (MN).

### SUMMARY

The device and computer implemented method according to the present invention may further reduce the runtime by determining an approximation of the Cholesky decomposition in 0 (N) operations.

According to an example embodiment of the present invention, the computer implemented method for predicting observations comprises providing an input for predicting an observation, and training data comprising pairs of an input and an observation, wherein the input characterizes a technical system, in particular a robot, preferably an autonomous vehicle, a manufacturing machine, a power tool, a home appliance, a personal assist system, a medical imaging device, wherein the observation characterizes the technical system or an environment of the technical system, wherein the method comprises determining, for the inputs a covariance matrix of the inputs, determining a pivoted Cholesky decomposition of the covariance matrix, and determining a prediction for an observation depending on the pivoted Cholesky decomposition of the covariance matrix, wherein determining the pivoted Cholesky decomposition comprises determining a covariance matrix of selected inputs and a covariance matrix of remaining inputs representing the covariance matrix of the inputs, determining a pivot index depending on a measure for a difference between the covariance matrix of the remaining inputs and a Nyström approximation of the covariance matrix of the remaining inputs.

According to an example embodiment of the present invention, the method may comprise determining, depending on the predicted observation, a control signal for the technical system, or a classification or a regression, in particular a state of health, a wear or fatigue of a material or component, characterizing the technical system, or a classification, in particular of an object, preferably a traffic sign, a traffic participant, infrastructure, a tool, a workpiece in the environment of the technical system.

According to an example embodiment of the present invention, the method may comprise determining the classification and a control signal for the technical system depending on the classification or determining the regression and a control signal for the technical system depending on the regression.

Providing the training data may comprise providing at least one pair of an input that is captured in particular with a sensor, preferably with a camera, a lidar sensor, a radar sensor, a motion sensor, an infrared sensor, an ultrasound sensor, a velocity sensor, an acceleration sensor, a yaw-rate sensor, a steering angle sensor, temperature sensor, a voltage sensor, a current sensor, a power sensor, and an observation of a control signal for the technical system, or a classification or a regression that is observed for the input.

Providing the input may comprise capturing the input, in particular with a sensor, preferably with a camera, a lidar sensor, a radar sensor, a motion sensor, an infrared sensor, an ultrasound sensor, a velocity sensor, an acceleration sensor, a yaw-rate sensor, a steering angle sensor, temperature sensor, a voltage sensor, a current sensor, a power sensor.

Determining the pivot index may comprise determining, for the inputs of the covariance matrix of the remaining inputs, in particular for the rows of the covariance matrix of the remaining inputs of the remaining inputs, a respective sum of the elements of the covariance matrix of the remaining inputs that are associated with the same input, in particular the elements of the respective row of the covariance matrix of the remaining inputs, determining for the inputs of the Nyström approximation of the covariance matrix of the remaining inputs, in particular for the rows of the Nystrom approximation, a respective sum of the elements of the Nyström approximation that are associated with the same input, in particular of the respective row of the Nystrom approximation, and determining the pivot index depending on the elementwise difference between the sums of the elements that are associated to the same input, in particular the row with the same index in the covariance matrix of the remaining inputs and the Nystrom approximation. The respective sums may be stored in a respective vector. The difference may be the determined as norm between the vectors.

According to an example embodiment of the present invention, preferably, the pivoted Cholesky decomposition is determined in iterations, wherein the sums of the elements of the Nystrom approximation are determined in the iterations, wherein the sums of the elements of the covariance matrix of the remaining inputs are determined once or not in all of the iterations. Determining the sums of the elements of the covariance matrix once or not in all iterations reduces the runtime further.

The sums of the elements of the Nystrom approximation are initialized to a predetermined value, in particular zero, in a first iteration, wherein a first Nyström approximation is determined in the initial iteration, and wherein the sums of the elements of the Nystrom approximation are determined depending on the first Nyström approximation in a second iteration.

According to an example embodiment of the present invention, at least one sum of the sums is weighted depending on a difference between the observation and the prediction for the observation that are associated with the same input as the sum.

According to an example embodiment of the present invention, the device for predicting observations, comprises at least one processor, and at least one memory, wherein the at least one processor is configured to execute instructions that, when executed by the at least one processor cause the device to execute the method, wherein the at least one memory is configured to store the instructions.

According to an example embodiment of the present invention, a data structure comprises a data field for an input for predicting an observation, a data field for a prediction of the observation, a data field for training data comprising pairs of an input and an observation, a data field for a covariance matrix of the inputs, a data field for a covariance matrix of the selected inputs of the covariance matrix of the inputs, a data field for a covariance matrix of remaining inputs of the covariance matrix of the inputs, a data field for a Nystrom approximation of the covariance matrix, a data field for pivot indices for a pivoted Cholesky decomposition of the covariance matrix, and a data field for difference between the covariance matrix of the remaining inputs and the Nyström approximation.

The data structure may comprise for the inputs a data field for a respective sum of the elements of the covariance matrix of the remaining inputs that are associated with the same input. This enables storing and re-using the sums to reduce the runtime.

Further embodiments of the present invention are derivable from the following description and the figures.

### BRIEF DESCRIPTION OF THE DRAWINGS

FIG. 1 schematically depicts a device for processing observations, according to an example embodiment of the present invention.

FIG. 2 depicts a flow chart with steps of a method for processing the observations, according to an example embodiment of the present invention.

### DETAILED DESCRIPTION OF EXAMPLE EMBODIMENTS

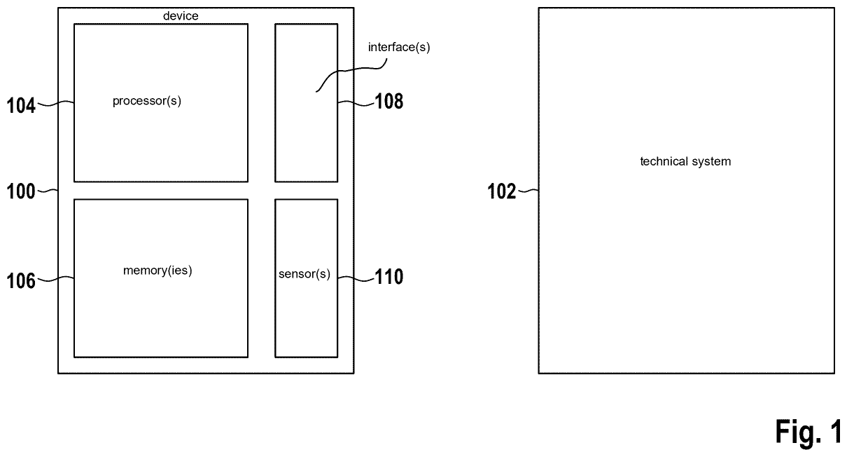

FIG. 1 schematically depicts a device 100 for processing observations. In the example, the observations relate to a technical system 102.

The technical system 102 may be a robot, preferably an autonomous vehicle, a manufacturing machine, a power tool, a home appliance, a personal assist system, a medical imaging device.

The device 100 comprises at least one processor 104.

The device 100 comprises at least one memory 106.

The device 100 comprises at least one interface 108.

The interface 108 is configured for receiving observations.

The device 100 is configured for processing the observations.

According to an example, the device 100 is configured for determining a control signal for a technical system depending on the observations.

According to an example, the device 100 is configured for determining a classification of the observations.

According to an example, the device 100 is configured for determining a regression of the observations.

The interface 108 is configured for outputting the control, the classification, or the regression.

According to an example, the device 100 comprises at least one sensor 110 that is configured for capturing the observations.

The interface 108 may comprise the at least one sensor 110. The interface 108 may be configured to receive the observations from the at least one sensor 110.

Observation in this context may refer to an image, in particular a digital image, a lidar image, a radar image, a motion sensor image, an infrared image, an ultrasound image, of the technical system 102 or an environment of the technical system 102. Observation in this context may refer to a physical quantity, e.g., a velocity, an acceleration, a yaw-rate, a steering angle, a temperature, a voltage, a current, a power of the technical system 102.

The at least one sensor 110 may comprise a camera, a lidar sensor, a radar sensor, a motion sensor, an infrared sensor, an ultrasound sensor, a velocity sensor, an acceleration sensor, a yaw-rate sensor, a steering angle sensor, temperature sensor, a voltage sensor, a current sensor, a power sensor.

The at least one processor 104 is configured for executing instructions that, when executed by the at least one processor 104 cause the device 100 to execute a method for processing the observations. The at least one memory 106 comprises at least one non-volatile memory. The at least one memory 106 is configured to store the instructions.

The at least one memory 106 is configured to store the observations.

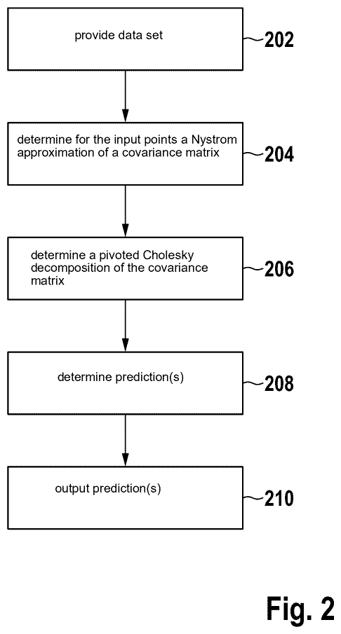

FIG. 2 depicts a flow chart with steps of a method for processing the observations.

The method is described below by way of example of conditioning a function ƒ that represents a Gaussian process (GP) for probabilistic modeling. The method conditions the function ƒ on the observations.

In an active learning, e.g. determining the control signal, for classification or regression, the method may incorporate prior knowledge about the function ƒ as well as a known covariance structure to help guide the exploration.

In the example, a prior over the function p(ƒ)˜GP(0, k) with a stationary kernel k with non-negative covariance is evaluated at N points X. According to an example the kernel k is an exponential quadratic kernel with automatic relevance determination:

$$k ( x , {x}^{′} ) = θexp ( - \frac{( x - {x}^{′} ) Λ ( x - {x}^{′} )}{2} ) ,$$

wherein θ and Λ represent parameters of the kernel.

The method uses a joint distribution of input points x∈X, x_{*}∈X_{*}and observed values y=ƒ(x) to determine a prediction or predictions y_{*}=ƒ_{*}(x_{*)} for at least one input point x_{*}

$$( \begin{matrix}f \\ {f}_{*}\end{matrix} ) ∼ N ( 0 , ( \begin{matrix}{K}_{XX} & {K}_{{XX}_{*}} \\ {K}_{{XX}_{*}}^{T} & {K}_{{X}_{*} {X}_{*}}\end{matrix} ) )$$

wherein N is the normal distribution, and Kₓₓ=k(X, X), Kₓₓ_{_{*}}, =k(X, X_{*}), Kₓₓ_{_{*}}^{T}=k(X, X_{*)} T, Kₓ_{_{*}}ₓ_{_{*}}=k (X_{*}, X_{*}) are is the covariance matrices containing the pair-wise evaluations of k (·,·) applied to the points in X and/or Xx.

The predictive distribution for the prediction or the predictions ƒ_{*}is:

$$p ( {f}_{*} , {X}_{*} , X , f ) = N ( {f}_{*} \vert {μ}_{*} , {\sum }_{*} )$$

$${μ}_{*} = {K}_{{XX}_{*}}^{T} {K}_{XX}^{- 1} f$$

$${\sum }_{*} = {K}_{{X}_{*} {X}_{*}} - {K}_{{XX}_{*}}^{T} {K}_{XX}^{- 1} {K}_{{XX}_{*}}$$

If observations y=ƒ(x) are corrupted by independent and homogeneous Gaussian noise ∈˜N (0, σ_{y}¹I), then by the conjugacy of Gaussian distribution, the distribution of the prediction or the predictions ƒ_{*} is given by:

$$p ( {f}_{*} \vert {X}_{*} , X , y ) = N ( {f}_{*} \vert {μ}_{*} , {\sum }_{*} )$$

$${μ}_{*} = {K}_{{XX}_{*}}^{T} {K}_{y}^{- 1} y$$

$${\sum }_{*} = {K}_{{X}_{*} {X}_{*}} - {K}_{{XX}_{*}}^{T} {K}_{XX}^{- 1} {K}_{{XX}_{*}}$$

where I is the identity matrix of appropriate dimensions, and K_{y}=Kₓₓ+σ²I is a Gram matrix, i.e. symmetric and positive definite.

The method is described by way of example of the observations that are corrupted by independent and homogeneous Gaussian noise.

The method comprises a step 202.

The step 202 comprises providing a data set (X; Y), X∈R^{N×D}. The data set (X; Y) comprises N pairs {xᵢ, yᵢ}ᵢ₌₁^{N} of an input point Xᵢ=xᵢ∈X and an observed value yᵢ∈Y. The data set (X; Y) is an example for training data. In this notation, any dimensional indexing of the input points Xᵢ=xᵢ is ignored. As a short hand notation Kᵢⱼ=k (xᵢ, xⱼ)=Cov [ƒᵢ, ƒᵢ]=Cov [ƒ(xᵢ), ƒ(xⱼ)] and Kₓₓ=Cov [ƒₓ, ƒₓ] is used.

The method comprises a step 204.

The step 204 comprises determining for the input points xᵢ∈X a Nyström approximation of the covariance matrix Kₓₓ.

For determining the distribution of the prediction or the predictions ƒ_{*}, the covariance matrix Kₓₓ is approximated. In an example, the covariance matrix Kₓₓ is approximated with the Nyström approximation

$${\hat{K}}_{XX} = {K}_{XI} {K}_{II}^{- 1} {K}_{IX} \approx {K}_{XX}$$

with K_{xI} ∈ [symbol] ^{N×M}=Cov [ƒₓ, ƒ_{I}], and K_{II}∈ [symbol] ^{M×M}=Cov [ƒ_{I}, ƒ_{I}] being covariance matrices of the function ƒ evaluated at the respective data points.

The points I may be sampled uniformly from a set {1, . . . , N}, yielding an unbiased estimator. The points I may be sampled with a biased sampling strategy, i.e. a biased estimator, specifically targeting a statistical quantity of interest.

The method comprises a step 206.

The step 206 comprises determining, a pivoted Cholesky decomposition of the covariance matrix Kₓₓ, the pivoted Cholesky decomposition is determined in a Cholesky routine.

Step 206 comprises defining a permuted dataset

$$\tilde{X} = [ \begin{matrix}{X}_{1} \\ {X}_{R}\end{matrix} ]$$

wherein I denotes M<N indices of input points that have been selected, R denotes N-M indices of input points that remain.

According to an example, M<<N for the pivoted Cholesky decomposition in particular in active learning.

After M points have been selected, the resulting Cholesky factor is:

$${L}_{\tilde{X} I} = [ \begin{matrix}{L}_{II} \\ {{K}_{RI} ( {L}_{II} )}^{- T}\end{matrix} ] ∈ {ℝ}^{N \times M}$$

After M points have been selected, the following relationship applies:

$${P}^{T} X = \tilde{X}$$

$${P}^{T} {K}_{XX} P = {K}_{\tilde{X} \tilde{X}} = [ \begin{matrix}{K}_{II} & {K}_{IR} \\ {K}_{RI} & {K}_{RR}\end{matrix} ]$$

wherein the matrix P is a permutation matrix that has implicitly constructed during the Cholesky routine.

This means, the step 206 comprises determining a covariance matrix K_{II} of selected inputs and a covariance matrix K_{RR} of remaining inputs representing the covariance matrix Kₓₓ of the inputs.

Using the Nyström approximation, the relationship is

$${P}^{T} {K}_{XX} P = {K}_{\tilde{X} \tilde{X}} = [ \begin{matrix}{K}_{II} & {K}_{IR} \\ {K}_{RI} & {{K}_{RI} ( {K}_{II} )}^{- 1} {K}_{IR}\end{matrix} ]$$

This means, the covariance matrix of the remaining input points K_{RR} is approximated with the Nyström approximation:

$${K}_{RR} = {{K}_{RI} ( {K}_{II} )}^{- 1} {K}_{IR}$$

In the Cholesky routine, the pivoted Cholesky decomposition is numerically determined in iterations, wherein at an iteration m a pivot index πₘ ∈m, . . . , N is chosen, and the corresponding rows and columns of the system are swapped (m↔πₘ).

According to an example, instead of explicitly building the matrix P, the method may determine and use a vector of pivot indices π.

For example, the pivot indices π are swapped in the vector. This corresponds to swapping rows and columns (m↔πₘ) of the matrix P.

The index πₘ is determined with an acquisition function.

According to an example, a new pivot index πₘ is determined in an iteration m with the acquisition function

$${π}_{m} = arg {max}_{j \geq m} {‖ ( {K}_{RR} - {{K}_{RI} ( {K}_{II} )}^{- 1} {K}_{IR} ) {1}_{N} ‖}_{j}^{2} = arg {max}_{j \geq m} {‖ {s}_{X}^{*} - {s}_{X}^{( m )} ‖}_{j}^{2}$$

where K_{RR} is the covariance matrix and K_{RI} (K_{II})⁻¹K_{IT} the Nyström approximation of the covariance matrix that depends on a covariance matrix K_{II}, wherein I comprises the m indices πₘ that have been selected as pivot index previous iterations, where 1_{N} is a vector of 1 in dimension N.

This means, the step 206 comprises determining a pivot index πₘ depending on a measure for a difference between the covariance matrix of the remaining inputs K_{RR} and a Nyström approximation K_{RR}−K_{RI} (K_{II})⁻¹K_{IR} of the covariance matrix of the remaining inputs K_{RR}.

### Projected Covariance:

According to an example, s*ₓ=K_{RR} 1_{N} is a first vector and sₓ^{(m)} is a second vector. The first vector s*ₓ may be calculated before executing the method with one Minimum Viable Product (MVP). The second vector sₓ^{(m)} may be initialized for a first iteration m=0 of the method. The initial second vector sₓ⁽⁰⁾ for the method may be sₓ⁽⁰⁾=0_{N}. In an iteration m the second vector sₓ^{(m+1)} for a next iteration m+1 is determine. For example, the second vector sₓ^{(m+1)}=K_{RI} (K_{II})⁻¹K_{IR} 1_{N} in the iteration m.

The projected covariance is a efficient approximation to a greedy A-optimal selection. In comparison the greedy A-optimal selection, the projected covariance lowers the computational cost, e.g., energy or runtime, from 0 (N² M) to 0(NM²)+N². Weighted projected covariance:

According to an example, s*ₓ=K_{RR} (y−μₓ) is a first vector and sₓ^{(m+1)} K_{RI} (K_{II})⁻¹K_{IR} (y−μₓ) is a second vector. The first vector s*ₓ and the second vector sₓ^{(m+1)} comprises the initial residual (y−μₓ) instead of the 1_{N} vector. The first vector st may be calculated before executing the method with one Minimum Viable Product (MVP).

According to an example, a greedy least-squares selector such as Matching-Pursuit or Forward-Regression is used. The weighted projected covariance and using the greedy least-squares selector results in a reduction in runtime that is similar to the reduction achieved with the projected covariance.

The iterations are for example continued until a predetermined amount of iterations m is reached or the last index π is collected by the acquisition function.

This means, that determining the pivot index comprises determining, for the inputs a respective sum of the elements of the covariance matrix that are associated with the same input, and a respective sum of the elements of the Nyström approximation that are associated with the same input, and determining the pivot index depending on the elementwise difference between the sums of the elements that are associated to the same input in the covariance matrix and the Nyström approximation.

In the example, the elements of the covariance matrix that are associated with the same input are the elements of the respective row of the covariance matrix.

In the example, the elements of the Nyström approximation that are associated with the same input are the elements of the respective row of the Nyström approximation.

The elementwise difference is determined in the example, between the sums of the elements that are associated to the row with the same index in the covariance matrix and the Nyström approximation.

Instead of using the row index, the column index may be used to determine the sums and the difference of the elements with the same column index in the covariance matrix and the Nyström approximation.

This means, that in the weighted projected covariance at least one sum of the sums is weighted depending on a difference between the observation and the prediction for the observation that are associated with the same input as the sum.

The method comprises a step 208.

In the step 208, the prediction or predictions ƒ_{*} are determined.

### Linear System:

For modelling a linear system with a GP, the predictions ƒ_{*} represent the GP. The predictions ƒ_{*} are fitted to observations xᵢ, yᵢ depending on a linear system of N equations

$${\{ {K}_{\tilde{X} \tilde{X}} {x}_{i} = {y}_{i} \}}_{i = 1}^{N}$$

by a forward substitution and solving

$${L}_{\tilde{X} I} {y}_{l} = {P}^{T} b for {y}_{l}$$

and a backward substitution and solving

$${L}_{\tilde{X} I}^{T} {x}_{l} = {y}_{l} for {x}_{l}$$

wherein L_{\hat{X}I} is the Cholesky factor.

According to an example, the predictions ƒ_{*} are fitted to the pairs {xᵢ, yᵢ}ᵢ₌₁^{N} with a numerical solver in iterations. According to an example, the Cholesky factor

$${L}_{\tilde{X} I} = [ \begin{matrix}{L}_{II} \\ {{K}_{RI} ( {L}_{II} )}^{- T}\end{matrix} ] ∈ {ℝ}^{N \times M}$$

that is available from step 206 after M input points have been selected in step 206 is used as initial Cholesky factor for the solver.

### Sparse Modeling:

According to an example, the predictions ƒ_{*} represent new points.

For example, after M input points xᵢ have been selected in step 206 a new point ƒ_{*}(x_{*)} for a new input point x_{*} is determined depending on input points xᵢ, i∈I that have been selected based on an intermediate quantity a_{I}∈ [symbol] ^{M} as

$${f}_{*} ( {x}_{*} ) = {\sum }_{i ∈ I} k ( {x}_{*} , {x}_{i} ) {α}_{i} = {K}_{* I} {α}_{I}$$

According to an example, the intermediate quantity a_{I} is a least-squares approximator based on output points \tilde{y}

$${α}_{I} = {( {K}_{I \tilde{X}} {K}_{\tilde{X} I} )}^{- 1} {K}_{I \tilde{X}} \tilde{y}$$

According to an example, the intermediate quantity a_{I} is a regularized least-squares approximator based on output points \tilde{y}

$${α}_{I} = {( {K}_{I \tilde{X}} {K}_{\tilde{X} I} + {σ}^{2} {I}_{M} )}^{- 1} {K}_{I \tilde{X}} \tilde{y}$$

wherein IM represents the identity matrix of matching size and \tilde{y} represents

The method comprises a step 210.

The step 210 may comprise outputting the prediction or the predictions ƒ_{*}.

The method in the example predicts the prediction or predictions y_{*}=ƒ_{*}(x_{*)} for at least one input point x_{*}.

The step 210 may comprise determining, depending on the prediction or predictions y_{*} a control signal for the technical system 102.

The step 210 may comprise determining, depending on the prediction or predictions y_{*} a classification or a regression characterizing the technical system 102. The classification or regression may be a state of health, a wear or fatigue of a material or component of the technical system 102 or in the environment of the technical system 102.

The step 210 may comprise determining, depending on the prediction or predictions y_{*} a classification of at least a part of the environment of the technical system 102.

The step 210 may comprise determining, depending on the prediction or predictions y_{*} a classification of an object, preferably a traffic sign, a traffic participant, infrastructure, a tool in particular of the technical system 102, a workpiece in particular in the environment of the technical system 102.

The step 210 may comprise determining a control signal for the technical system 102 depending on the classification or the regression.

According to an example, the input is the image of the technical system 102 or the environment of the technical system 102.

According to an example, the technical system 102 is the robot.

According to an example the image comprises the object.

According to an example, the object is the tool of the technical system 102 or the workpiece in the environment of the technical system 102.

According to an example, the prediction is the state of health, the wear, or the fatigue of the object in the image.

According to an example, the technical system 102 is configured to use the object or to process the object. According to an example, the technical system 102 prevented from using the object or processing the object, depending on the prediction. For example, the technical system 102 is controlled to stop using the tool if the state of health or the wear or the fatigue of the workpiece indicates that the tool is unusable.

For example, the technical system 102 is controlled to stop processing the workpiece if the state of health or the wear or the fatigue of the workpiece indicates that processing the workpiece is complete.

According to an example, the object is the traffic sign, the traffic participant, or the infrastructure.

According to an example, the prediction is the class of the object, e.g., the type of traffic sign, or traffic participant, or infrastructure. The type of traffic sign may indicate to stop, yield to traffic, or move with priority in traffic.

According to an example, the prediction is a trajectory of the object or the technical system 102.

According to an example, the technical system 102 is controlled to start, continue or stop moving depending on the class of the object. According to an example, the technical system 102 is controlled to stop if the class of the object indicates to stop or to yield to traffic. According to an example, the technical system 102 is controlled to continue moving if the class of the object indicates to move with priority in traffic.

According to an example, the technical system 102 is controlled to start, continue or stop moving depending on the trajectory of the object or the technical system 102.

For example, the moving of the technical system 102 along the trajectory is stopped or continued on a different the trajectory in case it is detected that the trajectory of the object leads to a collision with the technical system 102 or the trajectory of the technical system 102 leads to a collision with the object.

The method may comprise determining a corresponding control signal for the technical system 102 depending on the classification or the regression.

What is claimed is:

1. A computer-implemented method for predicting observations for a technical system, comprising:
providing an input for predicting an observation, and training data including pairs of an input and an observation, wherein each input characterizes the technical system, and wherein each observation characterizes the technical system or an environment of the technical system;
determining, for the inputs, a covariance matrix of the inputs;
determining a pivoted Cholesky decomposition of the covariance matrix; and
determining a prediction for an observation depending on the pivoted Cholesky decomposition of the covariance matrix;
wherein the determining of the pivoted Cholesky decomposition includes determining a covariance matrix of selected inputs of the inputs and a covariance matrix of remaining inputs representing the covariance matrix of the inputs, and determining a pivot index depending on a measure for a difference between the covariance matrix of the remaining inputs and a Nystrom approximation of the covariance matrix of the remaining inputs.

2. The method according to claim 1, wherein the technical system is a robot, or an autonomous vehicle, or a manufacturing machine, or a power tool, or a home appliance, or a personal assist system, or a medical imaging device.

3. The method according to claim 1, further comprising:
determining, depending on the predicted observation: (i) a control signal for the technical system, or (ii) a classification or a regression representing a state of health, or a wear, or fatigue of a material or component, characterizing the technical system, or (iii) a classification of an object including a traffic sign, or a traffic participant, or infrastructure, or a tool, or a workpiece in the environment of the technical system.

4. The method according to claim 3, further comprising:
(i) determining the classification, and the control signal for the technical system depending on the classification, or (ii) determining the regression, and the control signal for the technical system depending on the regression.

5. The method according to claim 1, wherein the providing of the training data includes providing at least one pair of: (i) an input that is captured using a sensor, the sensor including a camera, or a lidar sensor, or a radar sensor, or a motion sensor, or an infrared sensor, or an ultrasound sensor, or a velocity sensor, or an acceleration sensor, or a yaw-rate sensor, or a steering angle sensor, or a temperature sensor, or a voltage sensor, or a current sensor, or a power sensor, and (ii) an observation of a control signal for the technical system, or a classification or a regression that is observed for the input.

6. The method according to claim 1, wherein the providing or the input includes capturing the input using a sensor, the sensor including: a camera, or a lidar sensor, or a radar sensor, or a motion sensor, or an infrared sensor, or an ultrasound sensor, or a velocity sensor, or an acceleration sensor, or a yaw-rate sensor, or a steering angle sensor, or a temperature sensor, or a voltage sensor, or a current sensor, or a power sensor.

7. The method according to claim 1, wherein the determining of the pivot index includes:
determining, for the inputs of the covariance matrix of the remaining inputs including for rows of the covariance matrix of the remaining inputs, a respective sum of elements of the covariance matrix of the remaining inputs that are associated with the same input, including the elements of the respective row of the covariance matrix of the remaining inputs,
determining for the inputs of the Nystrom approximation of the covariance matrix of the remaining inputs, including for rows of the Nyström approximation, a respective sum of elements of the Nyström approximation that are associated with the same input, of the respective row of the Nyström approximation, and
determining the pivot index depending on an elementwise difference between the sums of the elements that are associated to the same input, including the row with the same index in the covariance matrix of the remaining inputs and the Nyström approximation.

8. The method according to claim 7, wherein the pivoted Cholesky decomposition is determined in iterations, wherein the sums of the elements of the Nyström approximation are determined in the iterations, wherein the sums of the elements of the covariance matrix of the remaining inputs are determined once or not in all of the iterations.

9. The method according to claim 8, wherein the sums of the elements of the Nyström approximation are initialized to a predetermined value in a first iteration, wherein a first Nystrom approximation is determined in the initial iteration, and wherein the sums of the elements of the Nystrom approximation are determined depending on the first Nystrom approximation in a second iteration.

10. The method according to claim 7, wherein at least one sum of the sums is weighted depending on a difference between the observation and the prediction for the observation that are associated with the same input as the sum.

11. A device for predicting observations, comprising:
at least one processor; and
at least one memory;
wherein the at least one processor is configured to execute instructions that, when executed by the at least one processor cause the device to execute a method for predicting observations for a technical system, the method including the following steps:
providing an input for predicting an observation, and training data including pairs of an input and an observation, wherein each input characterizes the technical system, and wherein each observation characterizes the technical system or an environment of the technical system,
determining, for the inputs, a covariance matrix of the inputs,
determining a pivoted Cholesky decomposition of the covariance matrix, and
determining a prediction for an observation depending on the pivoted Cholesky decomposition of the covariance matrix,
wherein the determining of the pivoted Cholesky decomposition includes determining a covariance matrix of selected inputs of the inputs and a covariance matrix of remaining inputs representing the covariance matrix of the inputs, and determining a pivot index depending on a measure for a difference between the covariance matrix of the remaining inputs and a Nystrom approximation of the covariance matrix of the remaining inputs; and
wherein the at least one memory is configured to store the instructions.

12. A data structure, comprising:
a data field for an input for predicting an observation,
a data field for a prediction of the observation,
a data field for training data comprising pairs of an input and an observation,
a data field for a covariance matrix of the inputs,
a data field for a covariance matrix of selected inputs of the covariance matrix of the inputs,
a data field for a covariance matrix of remaining inputs of the covariance matrix of the inputs,
a data field for a Nystrom approximation of the covariance matrix of the remaining inputs,
a data field for pivot indices for a pivoted Cholesky decomposition of the covariance matrix, and
a data field for difference between the covariance matrix of remaining inputs and the Nyström approximation.

13. The data structure according to claim 11, wherein the data structure includes for the inputs a data field for a respective sum of elements of the covariance matrix of the remaining inputs that are associated with the same input.
